(19) United States
(12) Patent Application Publication
(10) Pub. No.: US 2013/0100637 A1
(43) Pub. Date: Apr. 25, 2013

(54) PRESS-KEY PANEL

(71) Applicants: Yingfeng Wang, Shanghai (CN); Fei Shen, Shanghai (CN); Aiwen Liu, Shanghai (CN)

(72) Inventors: Yingfeng Wang, Shanghai (CN); Fei Shen, Shanghai (CN); Aiwen Liu, Shanghai (CN)

(21) Appl. No.: 13/626,751

(22) Filed: Sep. 25, 2012

(30) Foreign Application Priority Data
Sep. 26, 2011 (CN) 201120363711.7

(51) Int. Cl. H01H 13/83

(52) U.S. Cl. CPC H01H 13/83
USPC 362/23.03

(57) ABSTRACT

The present disclosure relates to a press-key panel. The press-key panel includes a press-key circuit board, at least one press key, and a light source circuit board. The light source circuit board includes a light source, a power supply circuit, and light source wires. The press-key panel also includes a press-key circuit board interlayer, a light source circuit board interlayer, and light source transmission windows. The first-light transmission windows are configured to transmit light emitted by a light source. The press-key panel may further include a polyester film, a light-guiding diffusion film, a lightproof layer, a surface lamination, and a press key illumination window.

### CROSS-REFERENCE TO RELATED APPLICATIONS

The present application claims the benefit of and priority to Chinese Patent Application 201120363711.7, filed Sep. 26, 2011, the entire contents of which are hereby incorporated by reference in their entirety.

### BACKGROUND

Conventional press-key panels commonly use press keys made from either metal or plastic. Metal press keys are used more frequently because plastic press keys have a shorter life. Also, when electrically conductive contacts are added to the plastic press keys, the conduction may not be as effective as with metal press keys. Plastic press keys do have one advantage, however. In plastic press keys, a backlight effect can be displayed through the keys by adding point light sources or surface light sources under the keys. This method is available with plastic press keys because they may be formed to be semi-transparent. Metal press keys, on the other hand, block light. Therefore, the same backlight implementation cannot conventionally be used in press-key panels having metal press keys.

A conventional press-key panel typically includes a press-key circuit board provided with a metal press key, a circuit board interlayer positioned above the press-key circuit board, a polyester film positioned above the circuit board interlayer, and a surface lamination positioned above the polyester film. The press-key circuit board typically includes press key wires for connection with other circuits. The circuit board interlayer is typically an insulative material, and has a press key through hole at a position corresponding to the metal press key. In this conventional press-key panel, the circuit board interlayer is used to separate the metal press key from the polyester film when the metal press key is not pressed down. The interlayer also contacts the metal press key and the polyester film when the metal press key is pressed down. The polyester film and the surface lamination are present to protect the press key. This conventional press-key panel, as assembled, is difficult to use in dark environments. The metal press keys do not have a backlight and the press-key panel therefore cannot be seen without the aid of a lighting device in the conventional configuration.

### SUMMARY

An embodiment of the present disclosure relates to a press-key panel including a press-key circuit board. The press-key circuit board includes at least one press key. The press-key panel also includes a light source circuit board. The light source circuit board includes a light source positioned on the light source circuit board at a position adjacent to the press key, a power supply circuit configured to supply power to the light source, and light source wires from the light source circuit board.

In this embodiment, the press-key panel also includes a press-key circuit board interlayer positioned above the press-key circuit board. The press-key panel further includes a light source circuit board interlayer positioned above the light source circuit board and below the press-key circuit board. Finally, the press-key panel includes light source transmission windows formed on each of said light source circuit board interlayer, press-key circuit board, and press-key circuit board interlayer at positions corresponding to the light source on the light source circuit board. The light source transmission windows are configured to transmit light emitted by the light source.

Another embodiment of the present disclosure relates to a press-key panel including a press-key circuit board with press keys. The press-key panel also includes a light source circuit board. The light source circuit board includes a light source positioned below the press key on the light source circuit board, a power supply circuit for the light source, and light source wires introduced out from the light source circuit board.

The press-key panel also includes a light source circuit board interlayer positioned below the press-key circuit board and above the light source circuit board, a polyester film positioned above the press-key circuit board, and a light-guiding diffusion film positioned above the polyester film. In this embodiment, the press-key panel further includes a lightproof layer positioned above the light-guiding diffusion film, and light source transmission windows located on each of said light source circuit board interlayer, the press-key circuit board, and the polyester film. The light source transmission windows are positioned corresponding to the light source on the light source circuit board, and are configured to transmit light emitted by the light source. Finally, this embodiment of the press-key panel also includes a press key illumination window located on the lightproof layer at a position corresponding to the press key. The press key illumination window is configured to transmit light to illuminate the press key.

### BRIEF DESCRIPTION OF THE DRAWINGS

FIG. 1 is a cross-sectional view of the layer structure of a conventional press-key panel having at least one metal press key;

FIG. 2 is a cross-sectional view of the layer structure of a press-key panel, according to an exemplary embodiment;

FIG. 3 is a front view of a press-key panel having the layer structure shown in FIG. 2, according to an exemplary embodiment; and

FIG. 4 is an exploded view of the press-key panel shown in FIG. 3, according to an exemplary embodiment.

### DETAILED DESCRIPTION

The press-key panels according to the present disclosure will be described in detail below with reference to the accompanying drawings and specific embodiments.

As shown in FIG. 1, a conventional press-key panel typically includes a press-key circuit board 110 including a metal press key 111. The press-key circuit board 110 holds press key wires 112 for connection with other circuits. Positioned above the press-key circuit board 110 is a circuit board interlayer 120, then a polyester film 130 above the interlayer 120, and finally a surface lamination 140 above the polyester film 130.

The circuit board interlayer 120 is typically made from an insulative material, and has a press key through hole 121 at a position corresponding to the metal press key 111. In exemplary embodiments, when the metal press key 111 is pressed down, the circuit board interlayer 120 keeps the metal press key 111 and the polyester film 130 in contact. When the metal press key 111 is not pressed down, the interlayer 120 keeps the metal press key 111 separate from the polyester film 130. The polyester film 130 and the surface lamination 140 are present in order to protect the press key 111.

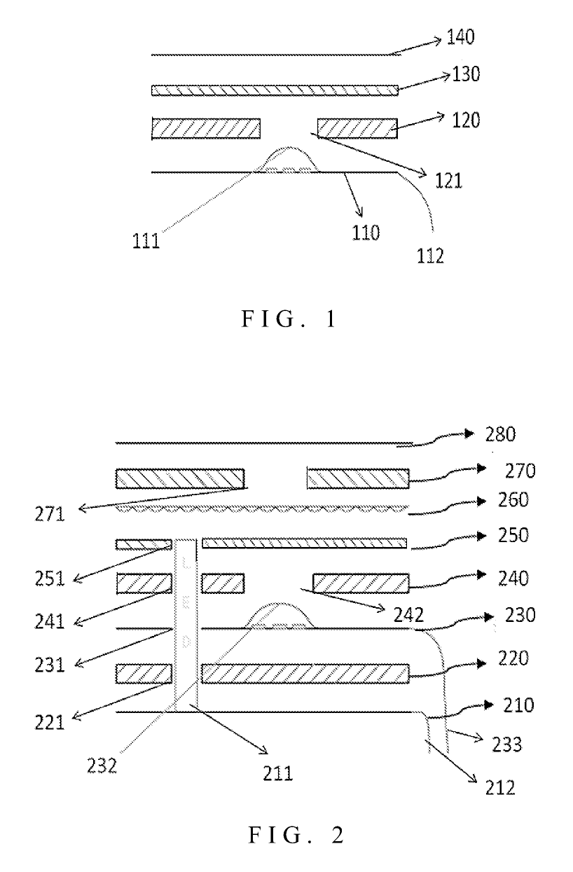

FIG. 2 shows the press-key panel layer structure of the present disclosure, according to an exemplary embodiment. In this embodiment, the press-key panel includes a light source circuit board 210. The light source circuit board 210 is made of a flexible film. The light source circuit board 210 is provided with a light emitting diode (LED) light source 211 and a power supply circuit for the light source (not shown in FIG. 2). Light source wires 212 are fed out from the circuit board 210.

As shown in FIG. 2, the LED light source 211 in the present embodiment is positioned on the light source circuit board 210, extending vertically and located adjacent to the press key 232 on the press-key circuit board 230. The LED light source 211 is used for backlighting in exemplary embodiments of press-key panels because conventional LED light sources are small, have a wide lighting angle and are especially bright.

A light source circuit board interlayer 220 is positioned above the light source circuit board 210. As shown in FIG. 2, a light source transmission window 221 is located on the light source circuit board interlayer 220 at a position corresponding to the LED light source 211. In exemplary embodiments, the light source transmission window 221 on the light source circuit board interlayer 220 is a through hole for the body of the LED light source 211 to pass through. If the LED light source 211 is very short in other embodiments, it may also be a portion inlaid with a light-transmitting material. Other portions of said light source circuit board interlayer 220 are made of an insulative material and are lightproof.

A press-key circuit board 230 is positioned above the light source circuit board interlayer 220. The press-key circuit board 230 in the present embodiment is made from a flexible film. In the present embodiment, the light source circuit board interlayer 220 is used as insulation between the light source circuit board 210 and the press-key circuit board 230 thereabove. Therefore, the thickness of the light source circuit board interlayer 220 is typically configured to be thin.

As shown in FIG. 2, a light source transmission window 231, a pot cover type metal press key 232 and press key wires 233 are located on the press-key circuit board 230. In the present embodiment, the light source transmission window 231 is located at a position corresponding to the LED light source 211. The light source transmission window 231 is a through hole for the body of the LED light source 211 to pass through. If the LED light source 211 is very short in other embodiments, it may also be inlaid with a light-transmitting material. In other embodiments, said metal press key 232 may also be replaced by a plastic press key.

FIG. 2 shows a press-key circuit board interlayer 240 positioned above the press-key circuit board 230. In exemplary embodiments, the press-key circuit board interlayer 240 includes a light source transmission window 241 and a press key through hole 242. The press-key circuit board interlayer 240 may keep the press key 232 from being overly protrusive and may make the surface of the press keys 232 more flat. If it is not necessary for the surface of the press keys 232 to be flat, the press-key circuit board interlayer 240 is not required.

In this embodiment, the light source transmission window 241 on the press-key circuit board interlayer 240 is located at a position corresponding to the LED light source 211. The light source transmission window 241 is a through hole for the body of the LED light source 211 to pass through. If the LED light source 211 is shorter in other embodiments, the light source transmission window 241 may also be inlaid with a light-transmitting material. The press key through hole 242 is located right above the pot cover type metal press key 232. The press key through hole 242 is used in this embodiment as it is in conventional press key panels.

In the present embodiment, a polyester film 250 is positioned above the press-key circuit board interlayer 240. As shown in FIG. 2, a light source transmission window 251 is located on the polyester film 250 at a position corresponding to the LED light source 211. The light source transmission window 251 in the present embodiment is a through hole for the body of the LED light source 211 to pass through. If the LED light source 211 is shorter in other embodiments, it may also be a portion inlaid with a light-transmitting material. As in conventional press key panels, the polyester film 250 has stable chemical properties, is static-free, and can protect the press key.

As shown in FIG. 2, a light-guiding diffusion film 260 is positioned above the polyester film 250. The light-guiding diffusion film 260 completely covers the top surface of the polyester film 250, uniformly diffusing the light from the light source. The light-guiding diffusion film 260 may be made of optical fiber, totally transparent PC, luminescence film, or another appropriate material.

A lightproof layer 270 is positioned just above the light-guiding diffusion film 260. In exemplary embodiments, the lightproof layer 270, other than a press key illumination window 271, is made of polyurethane. The lightproof layer 270 is coated with a black paint on the top surface thereof and a white paint on the bottom surface thereof. As shown in FIG. 2, in the present embodiment the lightproof layer 270 protects the press key 232.

A press key illumination window 271 is located on the lightproof layer 270 at a position corresponding to and right above the pot cover type metal press key 232. The press key illumination window 271 is a through hole or a portion inlaid with a light-transmitting material. The press key illumination window 271 allows light to be transmitted, illuminating the press key 232.

The lightproof layer 270 may not be required in embodiments where a significant light contrast in the press-key panel is not necessary. However, in exemplary embodiments it is recommended that the lightproof layer 270 be included in order to improve the contrast when the press-key panel lights up.

Lastly, a surface lamination 280 is positioned just above the lightproof layer 270. The surface lamination 280 is a film covering the entire lightproof layer 270.

FIG. 3 shows an embodiment of the press-key panel. In exemplary embodiments, the press-key panel 310 is shaped like a curved trapezoid, and is provided with a plurality of square metal press keys 311 thereon. The press-key panel 310 of the present embodiment is connected to an outlet terminal 320. The outlet terminal 320 is connected to one edge of the press-key panel 310, and contains signal transmission wires and power supply wires. These wires include press key wires 233 and light source wires 212 for connecting with components of the equipment where the press-key panel 310 is located.

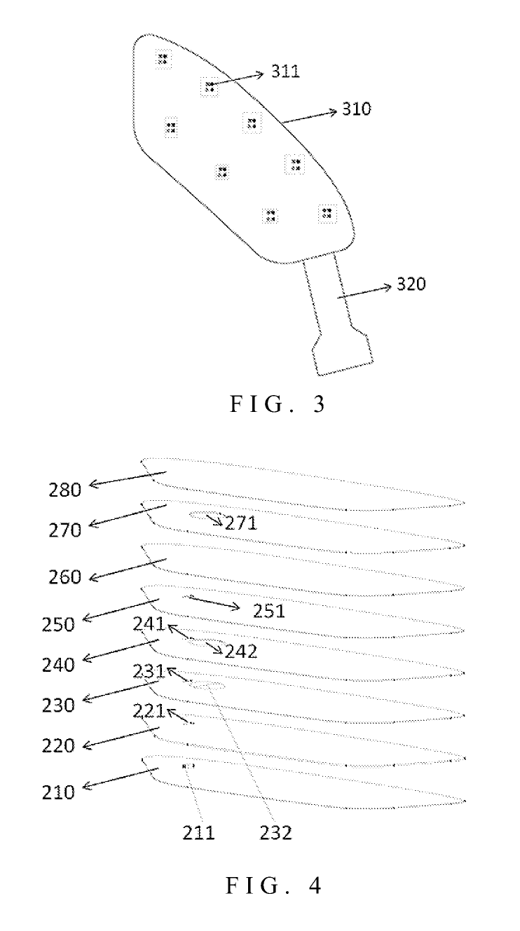

The layer structure of the press-key panel 310 is shown in FIG. 4. The press-key panel 310 has 8 layers. The first layer of the press-key panel 310, from the bottom, is a light source circuit board 210 provided with an LED light source 211 thereon. The LED light source 211 is positioned on the light source circuit board 210 at a location to the side and below the metal press key 232.

In the present embodiment, a single press key 232 may receive light from one or more light sources. A plurality of light sources may increase the backlight brightness and uniformity. However, a plurality of light sources will also take up more space in the press-key panel than a single LED light source 211. Therefore, the amount of LED light sources 211 may be greater than or equal to the amount of the metal press keys 232, depending on desired backlight intensity, space between press keys, and the cost. In FIG. 4, only one press key 232 and one LED light source 211 are shown for means of simple illustration.

The second layer of the press-key panel 310 is a light source circuit board interlayer 220. A light source transmission window 221 is located on the light source circuit board interlayer 220 at a position corresponding to the LED light source 211.

The third layer of the press-key panel 310 is a press-key circuit board 230 having a metal press key 232. A light source transmission window 231 is located on the press-key circuit board 230 at a position corresponding to the LED light source 211.

The fourth layer of the press-key panel 310 is a press-key circuit board interlayer 240 having a press key through hole 242. A light source transmission window 241 is located on the press-key circuit board interlayer 240 at a position corresponding to the LED light source 211.

The fifth layer of the press-key panel 310 is a polyester film 250. A light source transmission window 251 is located on the polyester film 250 at a position corresponding to the LED light source 211.

The sixth layer of the press-key panel 310 is a light-guiding diffusion film 260, which is a film covering the entire polyester film 250.

The seventh layer of the press-key panel 310 is a lightproof layer 270. A press key illumination window 271 is located on the lightproof layer 270 at a position corresponding to the metal press key 232.

The eighth layer of the press-key panel 310 is a surface lamination 280, which is a film covering the entire lightproof layer 270.

A press-key panel according to the present disclosure may advantageously achieve a backlight effect for both plastic press keys and metal press keys.

What is claimed is:

1. A press-key panel, comprising:
a press-key circuit board, including a press key;
a light source circuit board, said light source circuit board comprising:
a light source positioned on the light source circuit board at a position adjacent to the press key;
a power supply circuit, configured to supply power to the light source; and
light source wires, said light source wires introduced out from the light source circuit board;
a press-key circuit board interlayer, positioned above the press-key circuit board;
a light source circuit board interlayer, positioned above the light source circuit board and below the press-key circuit board; and
light source transmission windows formed on each of said light source circuit board interlayer, press-key circuit board and press-key circuit board interlayer at positions corresponding to the light source on said light source circuit board;
wherein said light source transmission windows are configured to transmit light emitted by said light source.

2. The press-key panel as in claim 1, said press-key panel further comprising:
a polyester film positioned above said press-key circuit board interlayer;
a light-guiding diffusion film positioned above said polyester film;
a lightproof layer positioned above the light-guiding diffusion film;
a surface lamination positioned above the lightproof layer;
a light source transmission window located on said polyester film at a position corresponding to the light source on said light source circuit board; and
a press key illumination window located on said lightproof layer at a position corresponding to the press key for light transmission to illuminate the press key.

3. The press-key panel as in claim 2, wherein the light source transmission windows on each of said light source circuit board interlayer, press-key circuit board, press-key circuit board interlayer and polyester film are configured to provide through holes for said light source body to pass through, and the press key illumination window on said lightproof layer is also configured to provide a through hole.

4. The press-key panel as in claim 2, wherein the light source transmission windows on each of said light source circuit board interlayer, press-key circuit board, press-key circuit board interlayer and polyester film are inlaid with a light-transmitting material, and the press key illumination window on said lightproof layer is inlaid with a light-transmitting material.

5. The press-key panel as in claim 2, wherein said lightproof layer, except for the portion containing the press key illumination window, is made of polyurethane, the polyurethane coated with a black paint on the top surface thereof and coated with a white paint on the bottom surface thereof.

6. The press-key panel as in claim 2, wherein said light-guiding diffusion film is a film that completely covers said polyester film.

7. The press-key panel as in claim 6, wherein said light-guiding diffusion film is made of optical fiber.

8. The press-key panel as in claim 6, wherein said light-guiding diffusion film is made of totally transparent PC.

9. The press-key panel as in claim 2, wherein said press-key panel is in the shape of a curved trapezoid.

10. The press-key panel as in claim 9, said press-key panel further comprising a plurality of square press keys and an outlet terminal, wherein one side of the press-key panel is connected to said outlet terminal, said outlet terminal including press key wires and light source wires, and said outlet terminal is configured to connect with external components.

11. The press-key panel as in claim 2, wherein both of said press-key circuit board and said light source circuit board are flexible circuit boards.

12. The press-key panel as in claim 2, wherein the press key on said press-key circuit board is a pot cover type metal press key.

13. The press-key panel as in claim 2, wherein the light source on said light source circuit board is an LED light source.

14. The press-key panel as in claim 2, wherein both of said press-key circuit board interlayer and said light source circuit board interlayer are made of an electrically insulative material.

15. The press-key panel as in claim 2, wherein the number of light sources on said light source circuit board is at least the number of press keys on said press-key circuit board.

16. A press-key panel, comprising:
a press-key circuit board, including press keys;
a light source circuit board, said light source circuit board comprising:
a light source positioned below the press key on the light source circuit board;
a power supply circuit for the light source; and
light source wires introduced out from the light source circuit board;
a light source circuit board interlayer, positioned below the press-key circuit board, and positioned above the light source circuit board;
a polyester film positioned above said press-key circuit board;
a light-guiding diffusion film positioned above said polyester film;
a lightproof layer positioned above the light-guiding diffusion film;
light source transmission windows located on each of said light source circuit board interlayer, said press-key circuit board and said polyester film, at positions corresponding to the light source on said light source circuit board, said light source transmission windows configured to transmit light emitted by said light source; and
a press key illumination window located on said lightproof layer at a position corresponding to the press key, said press key illumination window configured to transmit light to illuminate the press key.

17. The press-key panel as in claim 16, wherein said press-key panel further comprises a plurality of square press keys and an outlet terminal, wherein one side of the press-key panel is connected to said outlet terminal, said outlet terminal including press key wires and light source wires, and said outlet terminal is configured to connect with external components.

18. The press-key panel as in claim 16, wherein said lightproof layer, except for the portion containing the press key illumination window, is made of polyurethane, the polyurethane coated with a black paint on the top surface thereof and coated with a white paint on the bottom surface thereof.

19. The press-key panel as in claim 16, wherein the number of light sources on said light source circuit board is at least the number of press keys on said press-key circuit board.

20. The press-key panel as in claim 16, wherein said light-guiding diffusion film is made of a transparent material.
